(19) United States
(12) Patent Application Publication
(10) Pub. No.: US 2007/0085378 A1
(43) Pub. Date: Apr. 19, 2007

(54) Vehicle utility bed side panel

(75) Inventor: Bradley J. Hanson, North Augusta, SC (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/250,153

(22) Filed: Oct. 13, 2005

(51) Int. Cl. B62D 33/02

(52) U.S. Cl. 296/183.1

(57) ABSTRACT

A vehicle utility bed adapted for conveniently securing a cargo restraining device to the utility bed is provided. The utility bed includes a bottom panel, a front panel adjoining the bottom panel and a pair of opposing side panels adjoining the bottom and front panels. Each of the side panels includes a plurality of retainer pockets along a bottom surface of the respective side panel. The retainer pockets are utilized to securely retain at least a portion of cargo restraining device connectors so that the cargo restraining device will securely restrain cargo within the utility bed.

### FIELD OF INVENTION

The invention relates generally to vehicle utility beds, and more particularly to vehicle utility beds adapted to provide a convenient and effective apparatus and method for securing cargo straps to the utility bed.

### BACKGROUND OF THE INVENTION

Cargo or utility beds for vehicles such as trucks, utility vehicles, all-terrain vehicles and tractors are used to transport or haul many different types of materials, apparatuses, equipment, machinery, devices and any other object that will fit within or on the utility bed. It is often necessary to securely restrain such things within or to the utility bed. Well known cargo restraining devices, such as tie-down straps, ratchet-type straps, elastic restraining cords and cargo nets, are often utilized for this purpose. Such cargo restraining devices generally have connectors, e.g. hooks and clasps, that connect to retention devices, such as hooks, eyelets or rails, along a top surface of a utility bed side panel or along an interior surface of the side panel within an interior area of the utility bed.

Hooks, eyelets or rails along the top or interior surfaces of the side panels can be ineffective in securely restraining or tying down cargo because they often do not allow for adequate leverage to be applied to the restraining device. Or, if sufficient leverage can be applied to tighten the restraining device, the force can cause the utility bed side panels to flex or buckle, particularly with one-piece molded utility beds.

Therefore, it is desirable to provide a retention system and method for restraining cargo within or on a utility bed that allows adequate leverage and substantial force to be applied to securely restrain the cargo within or on the utility bed.

### BRIEF SUMMARY OF THE INVENTION

In one embodiment of the present invention, a vehicle utility bed adapted for conveniently securing a cargo restraining device to the utility bed is provided. The utility bed includes a bottom panel, a front panel adjoining the bottom panel and a pair of opposing side panels adjoining the bottom and front panels. Each of the side panels includes a plurality of retainer pockets along a bottom surface of the respective side panel. The retainer pockets are utilized to securely retain at least a portion of cargo restraining device connectors so that the cargo restraining device will securely restrain cargo within the utility bed.

Generally at least of a portion of a first connector of the cargo restraining device is inserted into one of the retainer pockets along the bottom surface of one of the side panels. At least a portion of a second connector of the cargo restraining device is also inserted into one of the retainer pockets along the bottom surface of the opposing side panel of the utility bed. The cargo restraining device is then adjusted, e.g. tightened, such that a force is exerted on the first and second connectors that securely retains the respective connector portions within the respective retainer pockets. Therefore, the cargo restraining device is securely connected to the utility bed and can be adjusted to securely restrain cargo within the utility bed.

Further areas of applicability of the present invention will become apparent from the detailed description provided hereinafter. It should be understood that the detailed description and specific examples, while indicating various embodiments of the invention, are intended for purposes of illustration only and are not intended to limit the scope of the invention.

### BRIEF DESCRIPTION OF THE DRAWINGS

The present invention will become more fully understood from the detailed description and accompanying drawings, wherein;

FIG. 1 is a side view of a utility bed side panel, in accordance with one embodiment of the present invention;

FIG. 2 is a sectional view of a portion of the side panel shown in FIG. 1 illustrating one of a plurality of cargo restraining device retaining recesses, also shown in FIG. 1;

FIG. 3 is an isometric top view of a utility bed incorporating the side panel shown in FIG. 1;

FIG. 4 is an isometric bottom view of a one-piece utility bed incorporating the side panel shown in FIG. 1;

FIG. 5 is a bottom view of a utility bed incorporating the side panel shown in FIG. 1; and

FIG. 6 is a flow chart illustrating a method for securing cargo in a vehicle utility bed, in accordance with the present invention.

Corresponding reference numerals indicate corresponding parts throughout the several views of drawings.

### DETAILED DESCRIPTION OF THE INVENTION

The following description of various embodiments is merely exemplary in nature and is in no way intended to limit the invention, its application or uses. Additionally, the advantages provided by the embodiments, as described below, are exemplary in nature and not all embodiments provide the same advantages or the same degree of advantages.

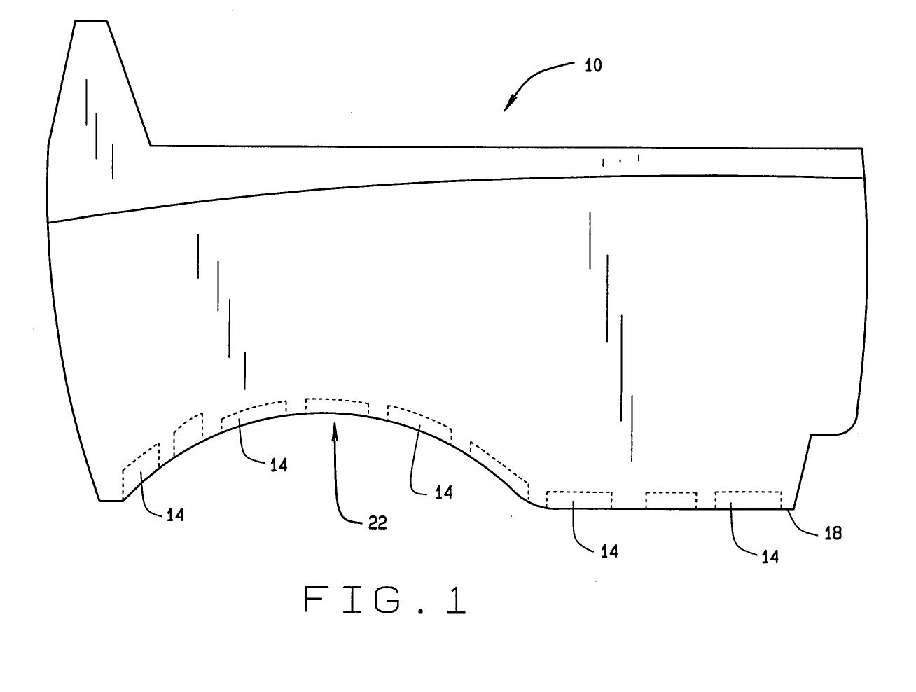

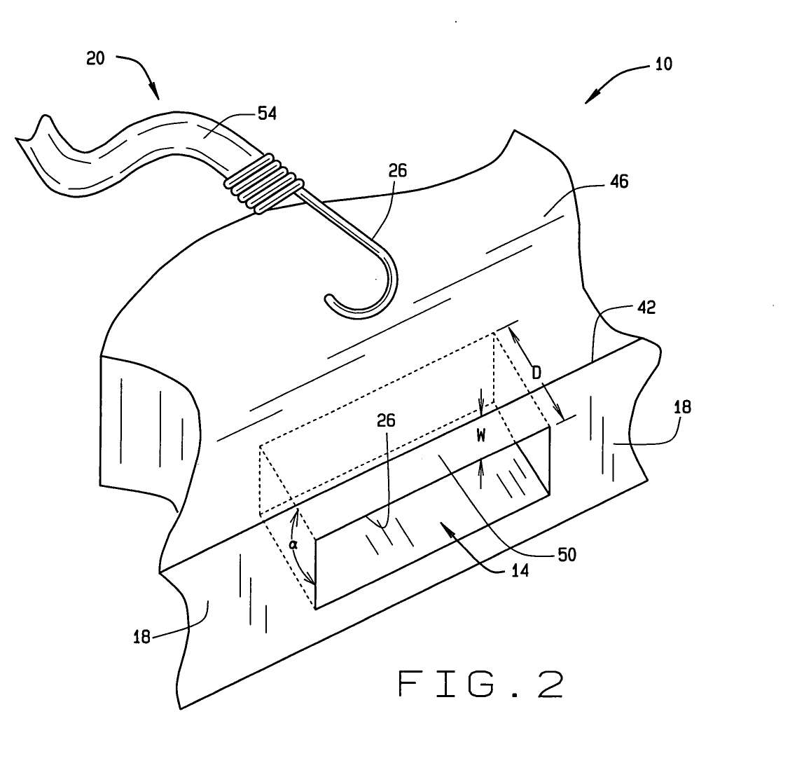

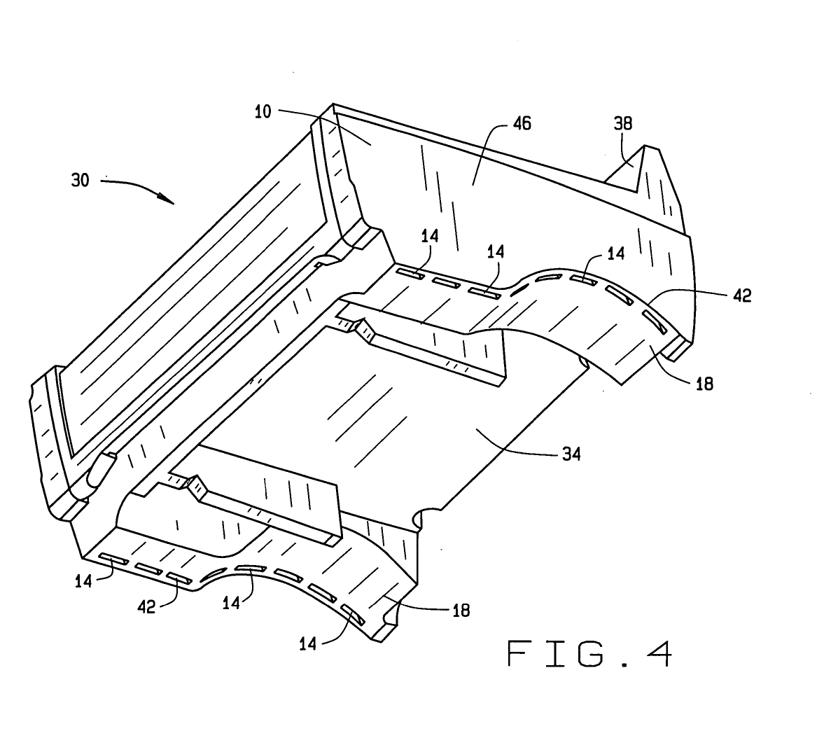

Referring to FIG. 1, a utility bed side panel 10 includes a plurality of cargo restraining device retaining recesses or pockets 14 (shown in phantom) along a bottom surface 18 of the side panel 10. The recesses 14 are utilized to connect a cargo restraining device 20 (shown in FIG. 2) to the side panel 10. The cargo restraining device 20 can be any device, apparatus or object used to restrain cargo within a vehicle utility bed, such as tie-down straps, ratchet-type straps, elastic restraining cords and cargo nets. The bottom surface 18 is more clearly shown in FIGS. 4 and 5. Preferably, the recesses 14 are equally spaced apart along the bottom surface 18. For example, the recesses 14 can be equally spaced, ½ inch, 1 inch, or 1½ inches apart. Alternatively, the spaces between the recesses 14 can vary along the bottom surface 18. The bottom surface 18 includes a wheel well portion 22. In some embodiments the recesses 14 are spaced along substantially the entire length of the bottom surface 18, including the wheel well portion 22. In an alternative implementation, various sections of the bottom surface 18 can include recesses 14 while other sections are absent any recesses 14. For example, distal end sections and a center section of the wheel well portion 22 of the bottom surface 18 may include one or two recesses 14, while the portions between the distal end sections and the center section of the wheel well portion 22 are absent recesses 14.

Although the recesses 14 are illustrated as having a rectangular shaped perimeter, the recesses 14 can have any shaped perimeter. For example, the perimeter of each recess 14 can have a circular, triangular, star, oval, parallelogram, or trapezoidal shape, and remain within the scope of the invention. Alternatively, the perimeters of the recesses 14 can each have a different shape, or various recess 14 perimeters can have a shape different than other various recess 14 perimeters.

Referring to FIG. 2, each recess 14 includes at least one side wall 26 that forms an angle α with the bottom surface 18. The angle α is of a degree sufficient to securely retain at least a portion of a connector 26 of the cargo restraining device 20. For example, the measure of angle α can be between 80° and 100°, such that at least a portion of a cargo restraining device connector 26, e.g. a J-hook or an S-hook, will be securely retained within the recess 14 when a force is applied to the cargo restraining device and will not slip or vibrate out of the recess 14. In one implementation, the side wall 26 forms substantially a 90° angle with the bottom surface 18 of the side panel 10. That is, the angle α equals approximately 90°. Additionally, each recess 14 has a depth D sufficient to receive and securely retain at least a portion of the cargo restraining device connector 26. For example the depth of each recess 14 can be ½ inch, ¾ inch 1 inch or any other suitable depth. As described above, the perimeters of each recess 14 can have the same shape or the perimeter shapes of the recesses 14 can vary from recess 14 to recess 14. Similarly, each recess 14 can have substantially the same depth D or various recesses 14 can have a different depth D than other various recesses 14. Furthermore, the dimensions of the perimeters of the recesses 14 can all be substantially the same or the recess 14 perimeter dimensions can vary. For example, if the perimeters of various recesses 14 have a circular shape, some recesses 14 can have a diameter that has a different measurement than the diameter of other recesses 14. Or, if various recesses 14 have a rectangular shaped perimeter, some of the rectangular recesses 14 can have a different length and/or width than other rectangular recesses 14.

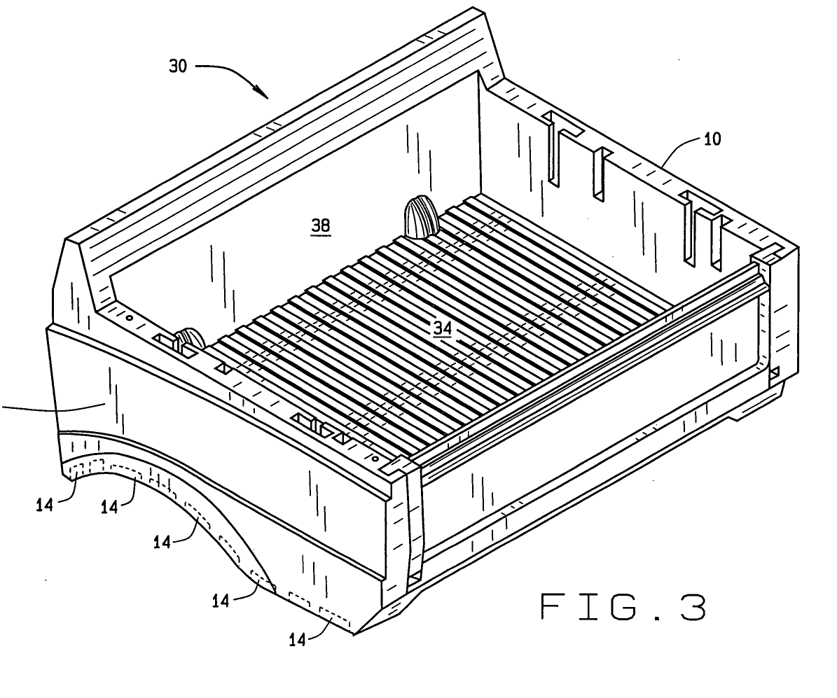

Referring now to FIG. 3, the side panel 10 comprises part of a utility bed 30 that also includes a second side panel 10, a bottom panel 34 and front panel 38. The side panels 10, bottom panel 34, and front panel 38 are adjoined to form the utility bed 30. In some embodiments, the utility bed 30 is a one-piece utility bed having the side panels 10, bottom panel 34, and front panel 38 integrally formed with each other, as illustrated in FIG. 4. For example, the utility bed 30 is a one-piece plastic molded utility bed. In some embodiments, the side panels 10, bottom panel 34 and front panel 38 are formed independently and adjoined or coupled together using any suitable adjoining means, such as welding, riveting or using nuts and bolts, as illustrated in FIG. 5.

Referring now to FIGS. 2, 4 and 5, in some implementations, the recesses 14 are located in close proximity to and adjacent a lower edge 42 of the respective side panel 10. The lower edge 42 is the edge or corner formed by the bottom surface 18 and an outer surface 46 of the respective side panel 10. More specifically, each recess 14 is located in close proximity to the lower edge 42 such that a lip 50 is formed having a width W, most clearly shown in FIG. 2. The width W of the lip 50 is dimensioned such that the connector 26 of the cargo restraining device will substantially mate or fit with the lip 50. Therefore, the connector 26 will be retained via the recess 14 and lip 50 such that a substantial force can be applied to the cargo restraining device and the connector 26 will remain securely connected to the respective side panel 10. For example, if the cargo restraining device connector 26 is a hook, e.g. a J-hook or an S-hook, a first portion of the hook will extend into the recess 14 while second portion of the hook will extend around the lip 50 and along the outer surface 46 of the respective side panel 10. Thus, the lip 50 will fit within an internal U-shaped portion of a hook so that the hook is securely retained, will not slip out of the recess 14 and can bear a substantial amount of force. Additionally, any force applied to the respective side panel 10 by the cargo restraining device and subsequently by the cargo restraining device connector 26, will be a shear force as opposed to a lateral force. Accordingly, a substantial amount of force can be exerted on the respective side panel 10 by the cargo restraining device without flexing or buckling the side panel 10.

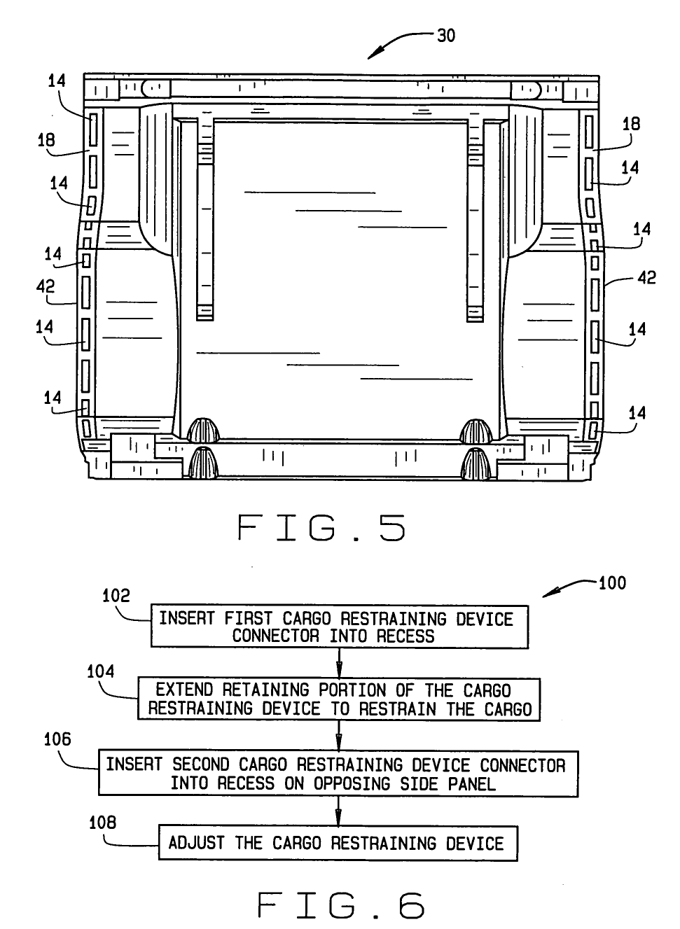

FIG. 6 is a flow chart 100 illustrating a method for securing cargo in vehicle utility bed, in accordance with the present invention. To secure cargo within the utility bed 30, at least a portion of at least one first cargo restraining device connector 26 is inserted into at least one of the recesses 14 along the bottom surface 18 of one of the utility bed side panels 10, as indicated at 102. Although FIG. 2 shows only one connector 26, it should be understood that the cargo restraining device 20 includes a second connector 26 at an opposing end or side of a retaining portion 54 of the cargo restraining device 20. If the cargo restraining device 20 includes more than one first connector 26, for instance a cargo net or tarp will have plurality of first connectors 26, then there will be an equal number of second connectors 26 at the opposing ends or side of retaining portion 54 of the cargo restraining device 20.

The retaining portion 54 of the cargo restraining device 20 is then extended across the cargo in a manner suitable to adequately restrain the cargo within the utility bed 30, as indicated at 104. At least a portion of at least one second cargo restraining device connector 26 is then inserted into at least one of the recesses 14 along the bottom surface 18 of the opposing utility bed side panel 10, as indicated at 106. In the case where the cargo restraining device 20 is an elastic restraining cord, the retaining portion 54 is merely stretched across the cargo and the second connector 26 inserted into the recess 14. However, in the case where the cargo restraining device 20 is an adjustable device, such as a tie-down strap or a ratchet-type strap, once the second connector 26 is inserted into the recess 14 of the opposing side panel 10, the cargo restraining device 20 is adjusted, e.g. tightened, to secure the cargo within or on the utility bed 30, as indicated at 108. Substantial force can be applied to each side panel 10 via adjustment of the cargo restraining device 20 to securely restrain the cargo to the utility bed 30 without flexing or buckling the side panels 10.

Thus, the present invention provides a retention system and method for restraining cargo within or on a utility bed that allows adequate leverage and substantial force to be applied to the cargo so that the cargo is securely restrained within or on the utility bed without flexing or buckling the utility bed side panels.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A utility bed side panel comprising a plurality of recesses along a bottom surface of the side panel, each recess including at least one side wall adapted to securely retain at least a portion of cargo restraining device connector within the recess.

2. The utility bed side panel of claim 1, wherein the side wall of each recess forms substantially a 90° angle with the side panel bottom surface.

3. The utility bed side panel of claim 1, wherein the recesses are spaced apart along substantially an entire length of the side panel bottom surface.

4. The utility bed side panel of claim 1, wherein the side panel comprises a side panel of a one-piece vehicle utility bed.

5. The utility bed side panel of claim 1, wherein the side panel comprised a side panel of a molded plastic one-piece vehicle utility bed.

6. The utility bed side panel of claim 1, wherein each recess is located in close proximity to and adjacent a lower edge of the side panel such that a lip is formed between the recess side wall and an outer surface of the side panel for securely retaining a cargo restraining device hook connector.

7. The utility bed side panel of claim 1, wherein various ones of the recesses have different shapes than other various ones of the recesses.

8. The utility bed side panel of claim 1, wherein various ones of the recesses have different depths than other various ones of the recesses.

9. A vehicle utility bed comprising:
a bottom panel;
a front panel adjoining the bottom panel; and
a pair of opposing side panels adjoining the bottom and front panels, each side panel including a plurality of retainer pockets along a bottom surface of the respective side panel, each retainer pocket adapted to securely retain at least a portion of a cargo restraining device connector.

10. The utility bed of claim 9, wherein each retaining pocket includes a side wall that forms substantially a 90° angle with the respective side panel bottom surface.

11. The utility bed of claim 9, wherein the retaining pockets are spaced apart along substantially an entire length of the respective side panel bottom surface.

12. The utility bed of claim 9, wherein the utility bed comprises a one-piece utility bed having the bottom, front and a side panels integrally formed therewith.

13. The utility bed of claim 9, wherein each retaining pocket is located in close proximity to and adjacent a lower edge of the respective side panel such that a lip is formed between the retaining pocket side wall and an outer surface of the respective side panel for securely retaining a cargo restraining device hook.

14. The utility bed of claim 9, wherein various ones of the retaining pockets have different shapes than other various ones of the retaining pockets of the respective side panel.

15. The utility bed of claim 9, wherein various ones of the retaining pockets have different depths than other various ones of the retaining pockets of the respective side panel.

16. A method for securing cargo in a vehicle utility bed, said method comprising:
inserting at least a portion of a first connector of a cargo restraining device in one of a plurality of retainer pockets along a bottom surface of a first side panel of the utility bed;
inserting at least a portion of a second connector of the cargo restraining device in one of a plurality of retainer pockets along a bottom surface of a second side panel of the utility bed; and
adjusting the cargo restraining device such that a force is exerted on the first and second connectors that securely retains the respective connector portions within the respective retainer pockets and cargo within the utility bed is restrained therein.

17. The method of claim 16, wherein each retaining pocket includes a side wall that forms substantially a 90° angle with the side panel bottom surface.

18. The method of claim 16, wherein the retaining pockets are spaced apart along substantially an entire length of the respective side panel bottom surface.

19. The method of claim 16, wherein the utility bed comprises a molded plastic one-piece utility bed having the side panels integrally formed therewith.

20. The method of claim 16, wherein each retaining pocket is located in close proximity to and adjacent a lower edge of the respective side panel such that a lip is formed between the retaining pocket side wall and an outer surface of the respective side panel for securely retaining a cargo restraining device hook.
